(19) United States
(12) Patent Application Publication
(10) Pub. No.: US 2025/0031614 A1
(43) Pub. Date: Jan. 30, 2025

(54) CUTTER HEAD, GRASS CHOPPING STRUCTURE, AND LAWN MOWER

(71) Applicant: Changyao Innovation Technology (Shenzhen) Co., Ltd, Shenzhen (CN)

(72) Inventors: Yue Hu, Shenzhen (CN); Cong Zhou, Shenzhen (CN); Fei Xie, Shenzhen (CN)

(21) Appl. No.: 18/917,034

(22) Filed: Oct. 16, 2024

(30) Foreign Application Priority Data
Jul. 10, 2024 (CN) 202410919085.7

(51) Int. Cl. A01D 34/73; A01D 101/00

(52) U.S. Cl. CPC A01D 34/733; A01D 2101/00

(57) ABSTRACT

Provided in the present disclosure are a cutter head, a grass chopping structure, and a lawn mower. The cutter head includes a cutter head body and blades; the cutter head body surface A is provided with a central part connected to a rotary driving component; the cutter head body edge part can be connected to a mowing cutter; and the blades are disposed on the cutter head body surface A. The grass chopping structure includes the cutter head and a protective cover sleeved on the cutter head body surface A and edge part, where the protective cover is provided with air guide holes along a circumferential direction of the cutter head. The lawn mower has the above cutter head or the above grass chopping structure. When the cutter head rotates, the blades also rotate together to generate airflow to implement grass chopping, thereby reducing the formation of grass clumps.

### FIELD OF TECHNOLOGY

The present disclosure relates to the technical field of lawn mower accessories, specifically to a cutter head, a grass chopping structure, and a lawn mower.

### BACKGROUND

With the popularization of urban greening and household gardening, lawn mowers have become an indispensable tool for maintaining lawns and vegetation.

In an existing lawn mower, especially a robotic lawn mower, a mowing part includes a cutter head and blades connected around the cutter head; and a motor drives the cutter head to rotate, so that the cutter head drives the blades to rotate to complete mowing.

During mowing, when grass is chopped and juice in the grass flows out, or grass clippings are wet by water, the grass clippings form grass clumps under the sticky effect of the juice or the water, and the grass clumps are discharged from the robotic lawn mower. These grass clumps not only affect the aesthetics of a lawn, but also accumulate on the lawn, thereby impacting the air permeability and drainability of the lawn, adding the work steps of clearing the grass clumps, and influencing the usage experience of the robotic lawn mower.

### SUMMARY

To overcome the deficiencies in the prior art, the present disclosure provides a cutter head, a grass chopping structure, and a lawn mower that can reduce grass clumps.

A first technical solution adopted by the present disclosure to solve the technical problems is as follows:
A cutter head, including a cutter head body and blades,
where the cutter head body has a cutter head body surface A, a cutter head body surface B opposite to the cutter head body surface A, and a cutter head body edge part;
the cutter head body surface A is provided with a central part connected to a rotary driving component;
the cutter head body edge part is capable of being connected to a mowing cutter; and
the blades are disposed on the cutter head body surface A and fixedly connected to the cutter head body surface A.

According to the cutter head as described above, the number of the blades is plural, and the blades are arranged radially from the central part of the cutter head body to the cutter head body edge part.

According to the cutter head as described above, the blades are equidistantly distributed on the cutter head body.

According to the cutter head as described above, the blades are arranged in an arc shape.

According to the cutter head as described above, the blade includes a blade end E close to the central part and a blade end F close to an edge of the cutter head body; and the height of the blade progressively increases from the blade end E to the blade end F.

According to the cutter head as described above, the blade includes a blade surface C and a blade surface D, and the slope of the blade surface C relative to a surface of the cutter head body progressively increases from the blade end E to the blade end F.

According to the cutter head as described above, the torsion of the blade progressively increases from the blade end E to the blade end F.

According to the cutter head as described above, the blade end F and the cutter head body edge part are located on a same vertical axis.

According to the cutter head as described above, the blade further includes a blade top end located between the blade surface C and the blade surface D; and

the blade end F includes a windward part, one end of the windward part is connected to the cutter head body edge part, and the other end of the windward part is connected to the blade top end.

According to the cutter head as described above, the windward part is tangent to a periphery of the cutter head body.

According to the cutter head as described above, a distance between the blade surface C and the blade surface D progressively increases in a direction from the blade top end to the cutter body surface A.

According to the cutter head as described above, the cutter head body surface A is inclined from the central part to the cutter head body edge part.

According to the cutter head as described above, the mowing cutter is in snap-fit connection with the cutter head body.

According to the cutter head as described above, the mowing cutter includes a blade, a connecting base, and a snap-fit joint;
the blade is rotatably connected to the connecting base;
the snap-fit joint is fixedly disposed on the connecting base; and
the cutter head body is provided with a snap-fit groove matched with the snap-fit joint.

A second technical solution adopted by the present disclosure to solve the technical problems is as follows:
A grass chopping structure, including the cutter head as described above and a protective cover sleeved on the cutter head body surface A and the cutter head body edge part,
where the protective cover is provided with a plurality of air guide holes along a circumferential direction of the cutter head.

A third technical solution adopted by the present disclosure to solve the technical problems is as follows:

A lawn mower, having the above cutter head or the above grass chopping structure.

The present disclosure has the following beneficial effects:

The blades are disposed on the cutter head body surface A, so that when the cutter head rotates, the blades also rotate together to generate airflow to implement grass chopping, thereby reducing the formation of grass clumps.

### BRIEF DESCRIPTION OF THE DRAWINGS

The present disclosure is further described below in conjunction with the accompanying drawings and embodiments.

FIG. 1 is a schematic diagram of a connection relationship among a cutter head, a mowing cutter, and a rotary driving component in the present disclosure;

FIG. 2 is a top view of a cutter head and a mowing cutter in the present disclosure;

FIG. 3 is a schematic diagram of a three-dimensional structure of a cutter head and a mowing cutter in the present disclosure;

FIG. 4 is a three-dimensional view of a mowing cutter in the present disclosure;

FIG. 5 is an exploded view of a mowing cutter in the present disclosure;

FIG. 6 is a schematic diagram of a structure before one side of a cutter head provided with a first snap-fit groove and a second snap-fit groove is connected to a mowing cutter in the present disclosure;

FIG. 7 is a schematic diagram of a structure after one side of a cutter head provided with a first snap-fit groove and a second snap-fit groove is connected to a mowing cutter in the present disclosure;

FIG. 8 is a schematic diagram of a structure before one side of a cutter head provided with a third snap-fit groove is connected to a mowing cutter in the present disclosure; and

FIG. 9 is a schematic diagram of a structure after one side of a cutter head provided with a third snap-fit groove is connected to a mowing cutter in the present disclosure.

Reference signs in the drawings are as follows:
1-mowing cutter; 10-blade; 11-first blade; 12-second blade; 13-connecting hole; 21-snap-fit joint; 211-first snap-fit joint; 2111-first lug; 212-second snap-fit joint; 2121-second lug; 3-connecting base; 31-mounting hole; 32-clamping component; 4-cutter head; 41-snap-fit groove; 411-first snap-fit groove; 412-second snap-fit groove; 413-third snap-fit groove; 414-first inclined guide groove; 415-second inclined guide groove; 42-cutter head body edge part; 43-central part; 5-screw; 501-threaded rod; 502-screw head; 51-first screw; 52-second screw; 6-blade; 61-blade top end; 62-windward part; and 7-rotary driving component.

### DETAILED DESCRIPTION OF THE EMBODIMENTS

The following will provide a clear and complete description of the concept, specific structure, and technical effects of the present disclosure in conjunction with the embodiments and accompanying drawings to fully understand the objective, features, and effects of the present disclosure. Apparently, the described embodiments are merely some rather than all of the embodiments of the present disclosure, and all other embodiments obtained by those skilled in the art based on the embodiments of the present disclosure without creative efforts fall within the scope of protection of the present disclosure. In addition, all the coupling/connection relationships referred to in the patent do not only mean that the components are directly connected, but also mean that a better connection structure can be formed by adding or reducing connection accessories according to specific implementation situations. The various technical features in the present disclosure can be interactively combined without conflicting with each other.

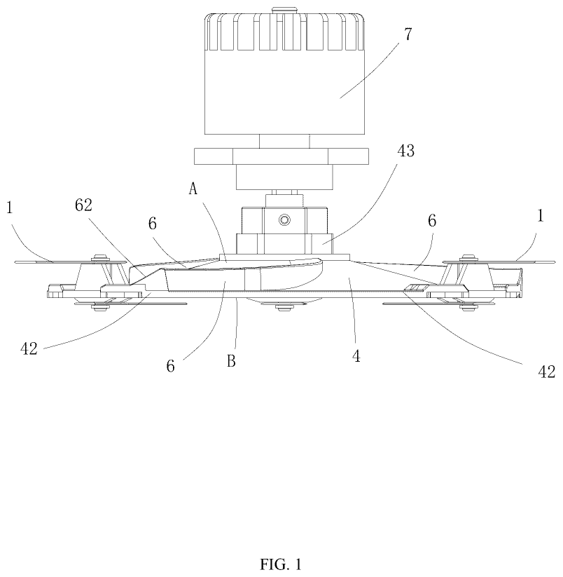

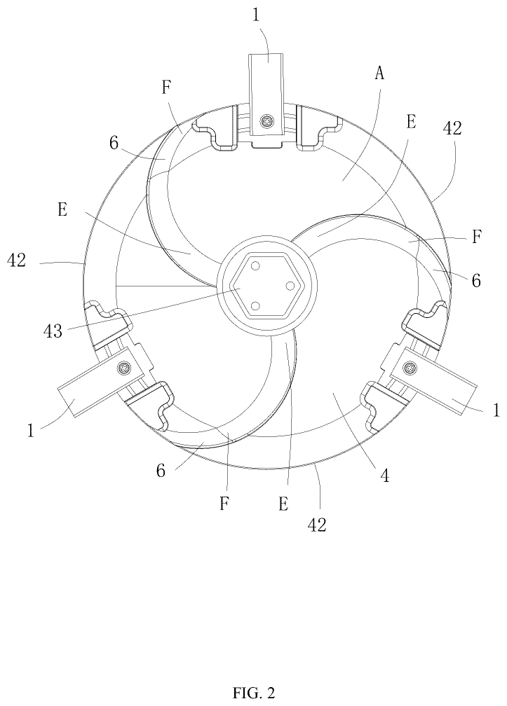

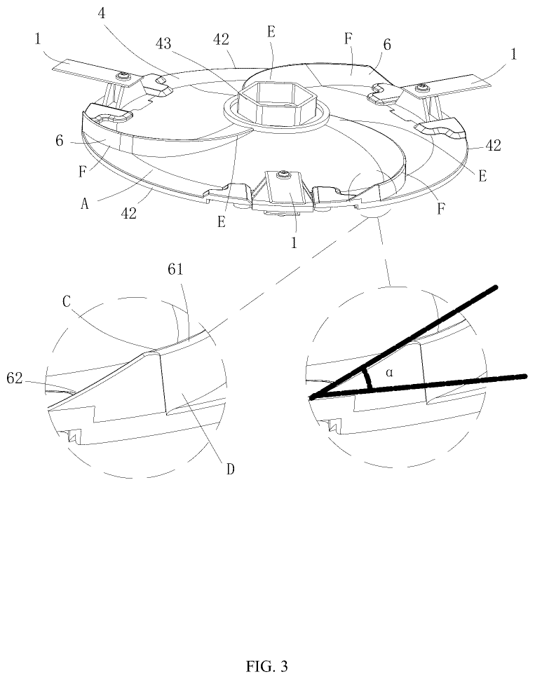

Referring to FIG. 1 to FIG. 3, a cutter head includes a cutter head body 4 and blades 6,

where the cutter head body 4 has a cutter head body surface A, a cutter head body surface B opposite to the cutter head body surface A, and a cutter head body edge part 42;

the cutter head body surface A is provided with a central part 43 connected to a rotary driving component 7;

the cutter head body edge part 42 is capable of being connected to a mowing cutter 1; and

the blades 6 are disposed on the cutter head body surface A and fixedly connected to the cutter head body surface A.

An output end of the rotary driving component 7 is connected to the central part 43. When the rotary driving component 7 is activated, the cutter head is driven to rotate. With the rotation of the blade 6, air molecules on the cutter head body surface A are pushed by the blade 6, so that the flow velocity of air is increased, the pressure is reduced, and a pressure difference with the surrounding environment is formed on the cutter head body surface A to cause the air to flow from a high-pressure region (a periphery of the cutter head body) to a low-pressure region (the cutter head body surface A).

During mowing, the mowing cutter 1 rotates to generate a centrifugal force, so that lightweight grass clippings are thrown up along a tangential direction of blade rotation under the centrifugal force at the moment of being cut, some grass clippings are thrown to the high-pressure region, and some grass clippings are thrown to the low-pressure region. Some of the grass clippings in the high-pressure region move to the low-pressure region under the pressure difference. At this time, there are a lot of grass clippings on the cutter head body surface A. Under the action of the blade 6, the air on the cutter head body surface A flows fast, and the air with high flow velocity is used to mess up the grass clippings to prevent them from aggregating, thereby reducing the formation of grass clumps. Subsequently, some grass clippings are thrown out of the cutter head under the centrifugal force of the cutter head body 4 and the blade 6 as well as the force of gravity, so that mowing, grass discharging, and grass chopping can be completed simultaneously, thereby reducing the formation of grass clumps. Moreover, when the grass clippings treated by the blade fall back onto the lawn, they are loose, so the air permeability and drainability of the lawn are not affected.

Therefore, it can be seen that in this embodiment, when the cutter head is in use, the cutter head body surface B faces the lawn, and the cutter head body surface A and the rotary driving component 7 face away from the lawn.

Specifically, the rotary driving component 7 transmits rotational motion of a power source to a device of the cutter head, such as a motor.

Further, the number of the blades 6 is plural, and the blades 6 are arranged radially from the central part 43 of the cutter head body to the cutter head body edge part 42. The blades 6 may be arranged in a manner of extending along a radial direction of the cutter head body 4 or deviating from a radial direction of the cutter head body 4. The plurality of blades 6 contributes to even distribution of airflow, increases the wind velocity, and reduces the rotational energy consumption of the rotary driving component 7. When the cutter head rotates, the air can be pushed more evenly from the central part 43 to the cutter head body edge part 42, so that the unevenness of the airflow is reduced, and the formation of turbulence and eddies is decreased, thus preventing excessive or insufficient airflow in local regions from affecting the grass discharging effect.

The blade 6 may be a flat blade, a spiral blade, an airfoil blade, etc. the number of the blades 6 may be 1 to 2. In this way, the cutter head is lightweight, and the inertia during rotation of the cutter head can be reduced. However, correspondingly, low air output will lead to poor grass chopping and discharging effects. the number of the blades 6 may also be 3 to 10 or even more, and can be selected according to the area of the cutter head, as long as the number of the blades 6 can maintain that the airflow can be formed during rotation of the cutter head to implement grass chopping and discharging. The cutter head in this drawing is used for a household robotic lawn mower. Due to the size limitation of the robotic lawn mower, the number of the blades 6 in the drawing of this embodiment is three.

Preferably, the number of the blades 6 is odd. When the number of the blades 6 is even, it means that one blade is disposed opposite each blade. Since all the blades have the same structure, when one of the blades rotates and vibrates, the probability that the opposite blade vibrates will also be greater, so that the impact of vibration on rotation of the cutter head is increased, and the smooth operation of the cutter head is affected, thus affecting the mowing effect. However, the odd number of the blades 6 can avoid this problem.

Specifically, the blades 6 are equidistantly distributed on the cutter head body 4 to ensure the uniformity and continuity of the airflow; and this contributes to maintaining the weight balance of the cutter head, thus preventing the vibration of the cutter head due to uneven weight from affecting the mowing effect.

Specifically, the blades 6 are arranged in an arc shape. Compared with blades in a straight line shape, the blades in the arc shape have a larger surface area, which means they have a larger area of contact with air, the direction of airflow formed when the cutter head rotates is stronger and more complex, and a better grass chopping effect is achieved.

More specifically, the blade 6 includes a blade end E close to the central part 43 and a blade end F close to an edge of the cutter head body 4; and the height of the blade 6 progressively increases from the blade end E to the blade end F. The height of the blade end F is greater than the height of the blade end E, and the blade end F can push a larger amount of air, so that a larger air volume can be generated. That is to say, a pressure at the blade end F is lower than a pressure at the blade end E. For example, when falling above the blade end E, the grass clippings move to the blade end F under the pressure difference. Moreover, because a distance from the blade end F to the central part 43 is greater than a distance from the blade end E to the central part 43, a centrifugal force generated by the blade end F will be greater, which can effectively throw out the grass clippings.

More specifically, the blade 6 includes a blade surface C and a blade surface D, and the slope of the blade surface C relative to a surface of the cutter head body 4 progressively increases from the blade end E to the blade end F. This slope represents an angle α of the blade surface C. The slope of the blade end E is low. When the cutter head rotates, the air molecules are pushed to be thrown out along the direction of the centrifugal force at the blade end E. Due to the great height of the blade end F, some of the thrown air molecules flow to the adjacent blade end F and then are pushed by the blade end F to be above the cutter head body surface A, thereby forming airflow from the blade end E to the blade end F. This airflow can drive the grass clippings to move, thus further reducing the air pressure at the blade end F, and improving the grass chopping effect.

More specifically, the torsion of the blade 6 progressively increases from the blade end E to the blade end F. The increase in torsion further increases the swept area and the rotational air volume of the blade end F, thereby increasing the air supply distance.

Specifically, the blade surface D is perpendicular to the cutter head body surface A, and the slope and torsion of the above blade 6 are indicators for measuring the shape of the blade surface C.

More specifically, an end part of the blade end F and the cutter head body edge part 42 are located on a same vertical axis. That is, the blade end F is adjacent to the cutter head body edge part 42. The mowing cutter 1 cuts the grass clippings. The grass clippings enter the low-pressure region more easily after being thrown up.

More specifically, the blade 6 further includes a blade top end 61 located between the blade surface C and the blade surface D; and

the blade end F includes a windward part 62, one end of the windward part 62 is connected to the cutter head body edge part 42, and the other end of the windward part 62 is connected to the blade top end 61. This kind of connection refers to the smooth transition connection between the windward part 62 and the cutter head body edge part 42 and the blade top end 61. The arrangement of the windward part 62 can reduce the resistance caused by the air to the cutter head during rotation. When the cutter head rotates, the windward part 62 can guide the air to flow towards the blade surface C, the blade surface D, and the blade top end 61, thus reducing the resistance caused by the air during initial rotation of the cutter head, and reducing the energy consumption of the rotary driving component 7.

More specifically, the windward part 62 is tangent to a periphery of the cutter head body 4. When the blades 6 are arc-shaped, the air resistance during rotation of the blades 6 can be further reduced.

More specifically, a distance between the blade surface C and the blade surface D progressively increases from the blade top end 61 to the cutter head body surface A. That is, viewed from the cross section, the blade surface C and the blade surface D are in an “A” shape. When the slope and torsion of the blade surface C relative to the surface of the cutter head body 4 progressively increases from the blade end E to the blade end F, the air resistance on the blade end F during rotation is greater than the air resistance on the blade end E, and the blade end F is more susceptible to airflow interference and vibration. Long-term use makes the blade end F more prone to deformation or breakage, affecting the grass chopping effect. The increase in the distance between the blade surface C and the blade surface D can enhance the structural strength of the blade 6, reduce the vibration of the blade 6, improve the deformation resistance of the blade 6, and lower the risk of breakage of the blade 6.

More specifically, the cutter head body surface A is inclined from the central part 43 to the cutter head body edge part 42. Under the action of gravity, the air molecules can be conveniently guided to flow from the central part 43 to the cutter head body edge part 42 to form airflow from the central part 43 to the cutter head body edge part 42, so as to guide the grass clippings to move from a part with low centrifugal force (the central part 43) to a part with high centrifugal force (the cutter head body edge part 42), which helps with grass discharging.

At present, a fixed mowing cutter is commonly used in the cutter head of the lawn mower on the market. As the usage time of the lawn mower increases, the blades of the mowing cutter have a poor mowing effect after wear and needs to be replaced. However, since the fixed mowing cutter is welded on the cutter head, the entire cutter head needs to be disassembled during replacement of the mowing cutter. This cutter head has a grass chopping function, so that it is too wasteful to replace the cutter head when the grass chopping structure is not damaged.

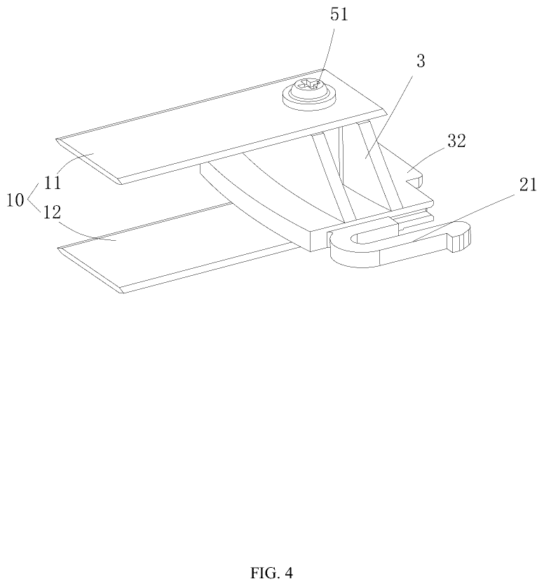

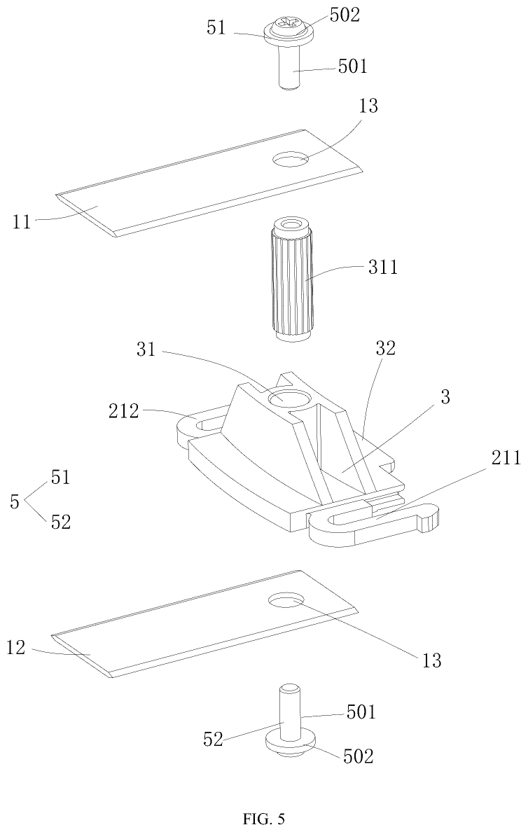

Referring to FIG. 4 to FIG. 9, as an improvement, the mowing cutter 1 and the cutter head body 4 are in detachable connection, such as insertion connection, snap-fit connection, or screw connection, which is convenient and fast for a user to replace the mowing cutter 1.

Taking the snap-fit connection as an example, how to implement the detachable connection is described in detail.

Further, the mowing cutter 1 includes a blade 10, a connecting base 3, and a snap-fit joint 21;
the blade 10 is rotatably connected to the connecting base 3;
the snap-fit joint 21 is fixedly disposed on the connecting base 3; and
the cutter head body 4 is provided with a snap-fit groove 41 matched with the snap-fit joint 21.

When the cutter head body 4 rotates, the blade 10 is thrown out under the centrifugal force for mowing. When it is necessary to operate the parts around the cutter head body 4, in order to avoid cutting injury by touching the blade 10, the blade 10 can be rotated to a suitable position for operation.

Specifically, the snap-fit joint 21 includes a first snap-fit joint 211 disposed on a left side of the blade 10 and a second snap-fit joint 212 disposed on a right side of the blade 10.

The first snap-fit joint 211 is provided with a first lug 2111, and the second snap-fit joint 212 is provided with a second lug 2121, where the first lug 2111 and the second lug 2121 may be semicircular protrusions or wedges.

The first snap-fit joint 211 and the second snap-fit joint 212 may be made of materials with rebound force, such as polyhexamethylene adipamide and modified acrylonitrile butadiene styrene (ABS) plastic.

The snap-fit groove 41 includes a first snap-fit groove 411 and a second snap-fit groove 412, where an opening of the first snap-fit groove 411 and an opening of the second snap-fit groove 412 are formed in a circumferential direction of the cutter head body 4, the first snap-fit groove 411 is matched with the first lug 2111, and the second snap-fit groove 412 is matched with the second lug 2121.

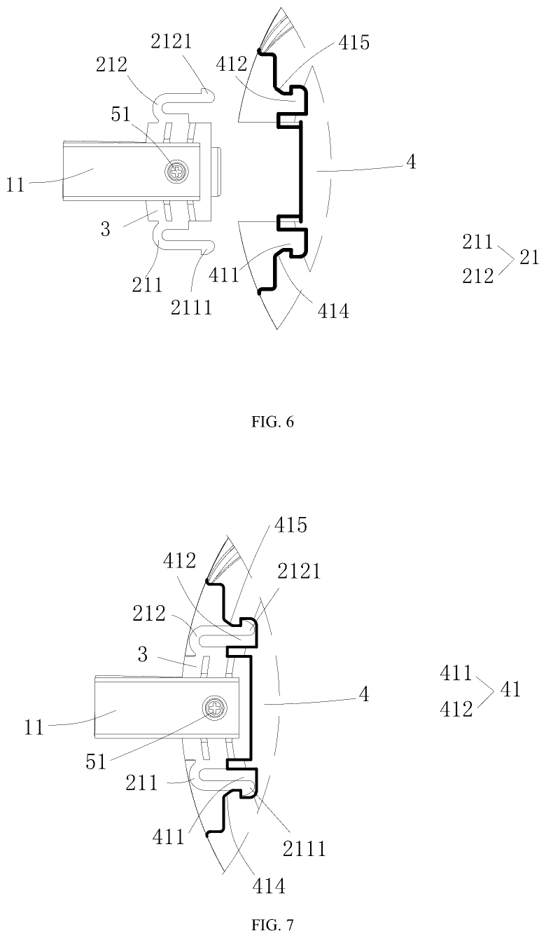

Such design allows the user to operate with one hand. Referring to FIG. 6, when the mowing cutter needs to be mounted, a thumb and an index finger can press against the first snap-fit joint 211 and the second snap-fit joint 212 respectively, apply force to squeeze the first snap-fit joint 211 and the second snap-fit joint 212 to deform them, and push the first lug 2111 and the second lug 2121 into the first snap-fit groove 411 and the second snap-fit groove 412, and the hand is released. Because the first snap-fit joint 211 and the second snap-fit joint 212 have the rebound force, the first snap-fit joint 211 and the second snap-fit joint 212 rebound when the hand is released, so as to fix the mowing cutter to the cutter head body. For a state, reference is made to FIG. 7. When the mowing cutter needs to be removed, the above operation process is reversed.

The blade 10 is fixedly connected to a middle of the connecting base 3, the first snap-fit joint 211 is connected to a left side of the connecting base 3, and the second snap-fit joint 212 is connected to a right side of the connecting base 3. The first snap-fit joint 211 and the second snap-fit joint 212 are disposed on two sides of the blade, which can provide better balance for the blade 10.

Because the blade 10 is a main consumable in the structure of the mowing cutter, the blade 10 is detachably connected with the connecting base 3. When the blade 10 is worn, the blade 10 can be replaced without mounting the connecting base 3, which further reduces the waste of materials.

More specifically, a screw 5 is further included. The screw 5 has a threaded rod 501 and a screw head 502, the middle of the connecting base 3 is provided with a mounting hole 31, and the blade 10 is provided with a connecting hole 13.

The diameter of the connecting hole 13 is greater than the diameter of the threaded rod 501 and less than the diameter of the screw head 502.

The threaded rod 501 passes through the connecting hole 13 and the mounting hole 31, so that the blade 10 is limited to moving between the screw head 502 and the connecting base 3.

Specifically, a nut 311 may be mounted in the mounting hole 31, or an inner wall of the mounting hole 31 may be provided with an internal thread matched with the threaded rod 501.

The threaded rod 501 is screwed into the nut 311 or the mounting hole 31 to be fixedly connected to the connecting base 3.

More specifically, the blade 10 includes a first blade 11 disposed at a top of the connecting base 3 and a second blade 12 disposed at a bottom of the connecting base 3.

The screw 5 includes a first screw 51 disposed at the top of the connecting base 3 and a second screw 52 disposed at the bottom of the connecting base 3.

The arrangement of double blades helps to increase the amount of mowing. The first blade 11 is rotatably connected to the connecting base 3 with the first screw 51 as a center, and the second blade 12 is rotatably connected to the connecting base 3 with the second screw 52 as a center. When the first blade 11 cuts grass, the second blade 12 can also cut the grass at the same time.

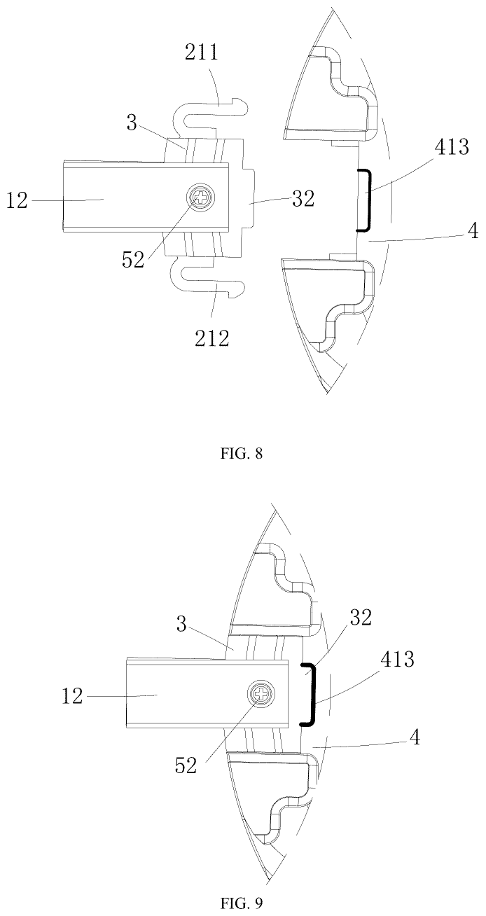

Referring to FIG. 8 and FIG. 9, more specifically, a clamping element 32 is further included. The clamping element 32 is fixedly connected to the connecting base 3, and the clamping element 32 is disposed between the first snap-fit joint 211 and the second snap-fit joint 212.

Further, the snap-fit groove 41 includes a first snap-fit groove 411, a second snap-fit groove 412, a first inclined guide groove 414, and a second inclined guide groove 415, of which openings are formed in the circumferential direction of the cutter head body 4.

The first snap-fit groove 411 and the second snap-fit groove 412 are both formed in one side of the cutter head body 4, and the other side of the cutter head body 4 is provided with a third snap-fit groove 413.

The clamping element 32 can be matched with the third snap-fit groove 413. The clamping element 32 matches with the first snap-fit joint 211 and the second snap-fit joint 212 to fix the mowing cutter along a height direction of the cutter head body 4, thereby further improving the firmness of mounting of the connecting base 3 and the cutter head body 4.

The first snap-fit groove 411 is adjacent to the first inclined guide groove 414. The first snap-fit groove 411 and the first inclined guide groove 414 are sequentially formed along a direction from the center of the cutter head body 4 to the circumference of the cutter head body 4.

The second snap-fit groove 412 is adjacent to the second inclined guide groove 415. The second snap-fit groove 412 and the second inclined guide groove 415 are sequentially formed along the direction from the center of the cutter head body 4 to the circumference of the cutter head body 4.

The second snap-fit groove 412 and the second inclined guide groove 415 can guide the first snap-fit joint 211 and the second snap-fit joint 212 to deform to be snapped into the first snap-fit groove 411 and the second snap-fit groove 412.

A grass chopping structure, including the cutter head as described above and a protective cover (not shown in figure) sleeved on the cutter head body surface A and the cutter head body edge part 42,

where the protective cover is provided with a plurality of air guide holes (not shown in figure) along a circumferential direction of the cutter head body. When the cutter head body is located in the protective cover, the grass clippings can collide with an inner wall of the protective cover and rebound to the cutter head body surface A when thrown up. By arranging the protective cover, output air from the blades 6 forms high-speed circulating airflow between the inner wall of the protective cover and the cutter head body surface A, thus further messing up the grass clippings, and reducing the probability of formation of grass clumps.

A lawn mower, having the cutter head as described above or the grass chopping structure as described above. Due to the above structure, the lawn mower also has the above advantages.

The above is a specific description of preferred embodiments of the present disclosure, but the present disclosure is not limited to the described embodiments. Those skilled in the art may also make various equivalent modifications or substitutions without departing from the spirit of the present disclosure, and these equivalent modifications or substitutions are all included within the scope of the claims of the present disclosure.

What is claimed is:

1. A cutter head, comprising:
a cutter head body (4) and blades (6),
wherein the cutter head body (4) has a cutter head body surface A, a cutter head body surface B opposite to the cutter head body surface A, and a cutter head body edge part (42);
the cutter head body surface A is provided with a central part (43) connected to a rotary driving component (7);
the cutter head body edge part (42) is capable of being connected to a mowing cutter (1); and
the blades (6) are disposed on the cutter head body surface A and fixedly connected to the cutter head body surface A.

2. The cutter head according to claim 1, wherein the number of the blades (6) is plural, and the blades (6) are arranged radially from the central part (43) of the cutter head body to the cutter head body edge part (42).

3. The cutter head according to claim 2, wherein the blades (6) are equidistantly distributed on the cutter head body (4).

4. The cutter head according to claim 1, wherein the blades (6) are arranged in an arc shape.

5. The cutter head according to claim 4, wherein the blade (6) comprises a blade end E close to the central part (43) and a blade end F close to an edge of the cutter head body (4); and the height of the blade (6) progressively increases from the blade end E to the blade end F.

6. The cutter head according to claim 5, wherein the blade (6) comprises a blade surface C and a blade surface D, and the slope of the blade surface C relative to a surface of the cutter head body (4) progressively increases from the blade end E to the blade end F.

7. The cutter head according to claim 5, wherein the torsion of the blade (6) progressively increases from the blade end E to the blade end F.

8. The cutter head according to claim 5, wherein an end part of the blade end F and the cutter head body edge part (42) are located on a same vertical axis.

9. The cutter head according to claim 5, wherein the blade (6) further comprises a blade top end (61) located between the blade surface C and the blade surface D; and
the blade end F comprises a windward part (62), one end of the windward part (62) is connected to the cutter head body edge part (42), and the other end of the windward part (62) is connected to the blade top end (61).

10. The cutter head according to claim 9, wherein the windward part (62) is tangent to a periphery of the cutter head body (4).

11. The cutter head according to claim 9, wherein a distance between the blade surface C and the blade surface D progressively increases in a direction from the blade top end (61) to the cutter body surface A.

12. The cutter head according to claim 9, wherein the cutter head body surface A is inclined from the central part (43) to the cutter head body edge part (42).

13. The cutter head according to claim 1, wherein the mowing cutter (1) is detachably connected to the cutter head body (4).

14. The cutter head according to claim 13, wherein the mowing cutter (1) is in snap-fit connection with the cutter head body (4).

15. The cutter head according to claim 14, wherein the mowing cutter (1) comprises a blade (10), a connecting base (3), and a snap-fit joint (21);
the blade (10) is rotatably connected to the connecting base (3);
the snap-fit joint (21) is fixedly disposed on the connecting base (3); and
the cutter head body (4) is provided with a snap-fit groove (41) matched with the snap-fit joint (21).

16. A grass chopping structure, comprising the cutter head according to claim 1 and a protective cover sleeved on the cutter head body surface A and the cutter head body edge part (42),
wherein the protective cover is provided with a plurality of air guide holes along a circumferential direction of the cutter head.

17. A lawn mower, having the cutter head according to claim 1.
